(19) United States
(12) Patent Application Publication
(10) Pub. No.: US 2012/0089767 A1
(43) Pub. Date: Apr. 12, 2012

(54) STORAGE DEVICE AND RELATED LOCK MODE MANAGEMENT METHOD

(75) Inventors: Won-chul Lee, Goyang-si (KR); Jeong-woo Lee, Seoul (KR)

(73) Assignee: SAMSUNG ELECTRONICS CO., LTD., Suwon-si (KR)

(21) Appl. No.: 13/193,638

(22) Filed: Jul. 29, 2011

(30) Foreign Application Priority Data
Oct. 12, 2010 (KR) 10-2010-0099452

(51) Int. Cl. G06F 12/02

(52) U.S. Cl. 711/103; 711/E12.008

(57) ABSTRACT

A storage device comprises at least one nonvolatile memory and a lock mode management module. The lock mode management module places the storage device in a soft lock mode in which only predetermined writing operations are allowed, upon determining that a number of reserved blocks in a flash memory is less than or equal to a reference value.

### CROSS-REFERENCE TO RELATED APPLICATIONS

This application claims priority under 35 U.S.C. §119 to Korean Patent Application No. 10-2010-0099452 filed on Oct. 12, 2010, the disclosure of which is hereby incorporated by reference in its entirety.

### BACKGROUND OF THE INVENTION

Embodiments of the inventive concept relate generally to electronic memory technologies. More particularly, embodiments of the inventive concept relate to nonvolatile data storage devices and methods for managing a lock mode of the storage devices.

Many electronic devices now use nonvolatile storage devices instead of hard disk drives (HDDs). A common example of such nonvolatile storage devices are solid state drives (SSDs). SSDs are now frequently incorporated in personal computers and laptops, for example.

SSDs and other forms of nonvolatile data storage can provide many benefits, such as the ability to withstand physical stress, relatively high storage capacity, and relatively low power consumption. Due to these and other benefits, developers continue to incorporate these devices in modern electronic systems. Moreover, in an effort to improve the performance of these devices, researchers continue to devote significant resources to expanding and improving their capabilities.

### SUMMARY OF THE INVENTION

According to one embodiment of the inventive concept, a storage device comprises at least one nonvolatile memory comprising a plurality of reserved blocks, and a lock mode management module that places the storage device in a soft lock mode upon determining that the number of reserved blocks is less than or equal to a reference value. The soft lock mode allows a predetermined writing operation while disallowing another writing operation.

According to another embodiment of the inventive concept, a lock mode management method is provided for a storage device comprising a plurality of flash memories. The method comprises placing the storage device in a soft lock mode upon determining that a number of reserved blocks of the flash memories is less than or equal to a reference value, performing a disk mounting operation to copy data from the storage device to another storage device while the storage device is in the soft lock mode, storing metadata related to the disk mounting operation, and after storing the metadata related to the disk mounting operation, placing the storage device in a hard lock mode.

According to another embodiment of the inventive concept, an information processing system comprises a host device, and a storage device responsive to commands provided from the host device. The storage device comprises at least one nonvolatile memory comprising a plurality of reserved blocks, and a lock mode management module that places the storage device in a soft lock mode upon determining that the number of reserved blocks is less than or equal to a reference value. The soft lock mode permits a predetermined writing operation to be performed while preventing another writing operation from being performed.

These and other embodiments can improve the reliability of data storage devices by maintaining backup data through write operations performed in a soft lock mode.

### BRIEF DESCRIPTION OF THE DRAWINGS

The drawings illustrate non-limiting and non-exhaustive embodiments of the inventive concept. The drawings are included to provide a further understanding of the inventive concept, and are incorporated in and constitute a part of this specification. In the drawings, like reference numbers indicate like features.

FIG. 1 is a block diagram of a memory system according to an embodiment of the inventive concept.

FIG. 2 is a block diagram illustrating a storage device of FIG. 1 according to an embodiment of the inventive concept.

FIG. 3 is a block diagram illustrating firmware in the storage device of FIG. 2 according to an embodiment of the inventive concept.

FIG. 4 is a diagram illustrating a bad block processing method performed by a bad block management module of FIG. 3 according to an embodiment of the inventive concept.

FIG. 5 is a flowchart illustrating a bad block replacing method performed in a programming operation of a flash memory of FIG. 2 according to an embodiment of the inventive concept.

FIG. 6 is a flowchart illustrating a bad block replacing method performed in an erasing operation of a flash memory of FIG. 2 according to an embodiment of the inventive concept.

FIG. 7 is a flowchart illustrating a bad block replacing operation of FIGS. 5 and 6 according to an embodiment of the inventive concept.

FIG. 8 is a flowchart illustrating an initialization operation of a storage device according to an embodiment of the inventive concept.

FIG. 9 is a diagram illustrating a soft lock mode entry time of the storage device of FIG. 2 according to an embodiment of the inventive concept.

FIG. 10 is a diagram illustrating a soft lock mode entry time of the storage device of FIG. 2 according to an embodiment of the inventive concept.

FIG. 11 is a flowchart illustrating a lock mode management method of a storage device according to an embodiment of the inventive concept.

FIG. 12 is a block diagram illustrating a computing system incorporating a storage device according to an embodiment of the inventive concept.

FIG. 13 is a block diagram illustrating an electronic appliance incorporating a storage device according to an embodiment of the inventive concept.

FIG. 14 is a block diagram illustrating a server system incorporating a storage device according to an embodiment of the inventive concept.

### DETAILED DESCRIPTION

Embodiments of the inventive concept are described below with reference to the accompanying drawings. The inventive concept may, however, be embodied in different forms and should not be construed as limited to the embodiments set forth herein. Rather, these embodiments are provided as teaching examples.

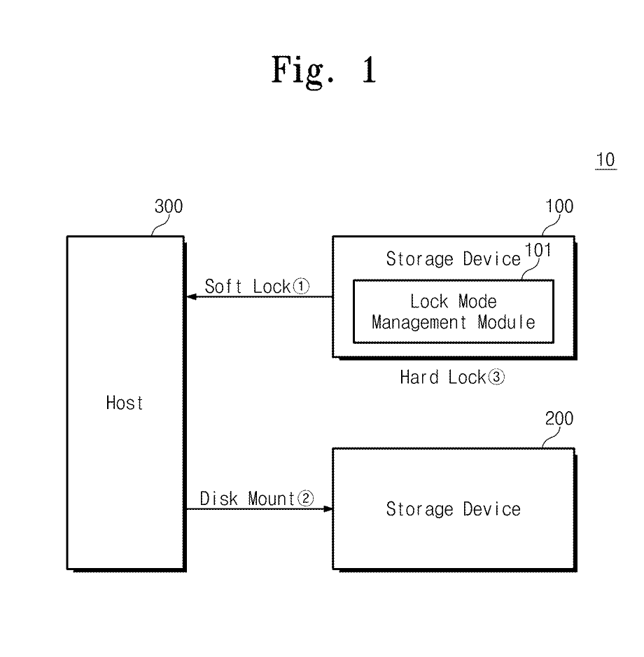

FIG. 1 is a block diagram of a memory system 10 according to an embodiment of the inventive concept.

Referring to FIG. 1, memory system 10 comprises a storage device 100, a storage device 200, and a host 300.

Storage device 100 comprises a nonvolatile memory, such as a NAND flash memory, a vertical NAND flash memory, a NOR flash memory, a resistive random access memory (RRAM), a phase-change random access memory (PRAM), a magnetoresistive random access memory (MRAM), a ferroelectric random access memory (FRAM), or a spin transfer torque random access memory (STT-RAM). The nonvolatile memory can be configured in a three-dimensional (3D) array structure, or it can take the form of a floating gate type flash memory or a charge trap flash (CTF) memory device. Moreover, in some embodiments, storage device 100 can take the form of an SSD.

Storage device 100 comprises a lock mode management module 101 that manages a plurality of lock modes. The lock modes typically include a soft lock mode and a hard lock mode of storage device 100.

The soft lock mode is entered as a consequence of the number of reserved blocks falling below a reference value. The soft lock mode prevents user data from being written in storage device 100, but it allows certain other types of writing operations. These other types of writing operations can include, for instance, writing operations for a disk mounting operation performed by a user of storage device 100. The disk mounting operation is an operation that copies data from storage device 100 to storage device 200.

In one example, storage device 100 enters the soft lock mode, and thereafter meta information used to recognize storage device 100 and to perform the disk mounting operation is written such that a user may back up data stored in storage device 100. When storage device 100 enters the soft lock mode, operations that are currently being performed are completed, and thus data is not lost.

The disk mounting operation is completed after storage device 100 is placed in the soft lock mode, and then storage device 100 is subsequently placed in the hard lock mode. In the hard lock mode, writing operations of storage device 100 are not performed, and only reading operations are performed. In other words, the hard lock mode can be considered a read-only mode. Information for operating in the soft lock mode and the hard lock mode is stored in storage device 100.

Lock mode management module 101 determines entry of the soft lock mode according to a current state or environment of storage device 100. In some embodiments, lock mode management module 101 monitors the number of predetermined data storage spaces of storage device 100, and where the number of predetermined data storage spaces reaches a reference value, lock mode management module 101 places storage device 100 in the soft lock mode. In some embodiments, lock mode management module 101 places storage device 100 in the soft lock mode where a data storage time is longer than a reference value, after receiving of a writing request from host 300.

After entering of the soft lock mode, lock mode management module 101 transmits a signal indicating that storage device 100 has entered the soft lock mode, to an external device, such as host 300. In response to the soft lock mode entry signal, a user of host 300 performs a disk mounting operation that copies data from storage device 100 to storage device 200.

After performing of the disk mounting operation, lock mode management module 101 places storage device 100 in the hard lock mode. In certain embodiments, during the disk mounting operation, control data of storage device 100 is stored, and then lock mode management module 101 places storage device 100 in the hard lock mode. In another embodiment, lock mode management module 101 places storage device 100 in the hard lock mode according to a request from the user of host 300. In another embodiment, lock mode management module 101 cancels the placing of storage device 100 in the hard lock mode.

Storage device 200 copies data from storage device 100 through the disk mounting operation. Herein, storage device 200 is a device comprising a nonvolatile memory or a volatile memory. In some embodiments, storage device 200 is an SSD or an HDD.

Host 300 stores data in storage device 100 or storage device 200, and reads data from storage device 100 or storage device 200. Host 300 can take a variety of forms, such as a personal computer, a digital camera, a PDA, an e-book, a mobile phone, a smart television, or a server.

A typical storage device may not perform the disk mounting operation after entering the soft lock mode. Consequently, a user may be required to visit a storage device manufacturer and request after-sale service (A/S).

Storage device 100 comprises lock mode management module 101, which manages the soft lock mode where a user performs the disk mounting operation, and manages the hard lock mode that is entered after performing of the disk mounting operation. Therefore, where the hard lock mode is entered, the user may not perform the disk mounting operation.

Hereinafter, for convenience, it is assumed that storage device 100 is an SSD. Furthermore, it is assumed that lock mode management module 101 of FIG. 1 is implemented by firmware. However, lock mode management module 101 is not limited thereto. For example, lock mode management module 101 can be configured in hardware.

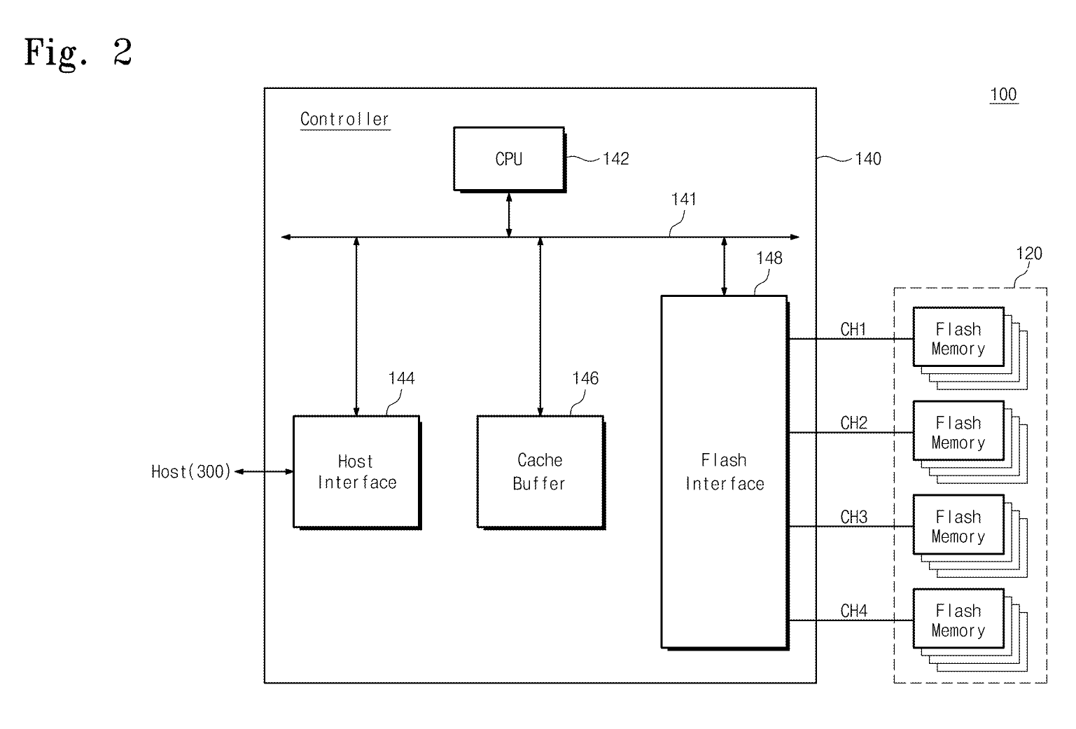

FIG. 2 is a block diagram illustrating storage device 100 of FIG. 1 according to an embodiment of the inventive concept.

Referring to FIG. 2, storage device 100 comprises a plurality of flash memories 120 and a memory controller 140.

Each of flash memories 120 is a single-item NAND flash memory. The NAND flash memory can be configured with single level cells (SLCs) storing single bit data, or multi-level cells (MLCs) storing multi-bit data.

Each of flash memories 120 can operate in a write/read mode, a read-only mode, or an inaccessible mode.

Memory controller 140 controls flash memories 120, and it comprises a central processing unit (CPU) 142, a host interface 144, a cache buffer 146, and a flash interface 148.

Host interface 144 exchanges data with host 300 according to a predetermined communication protocol under the control of CPU 142. The communication protocol can be one of various standard interface protocols such as a universal serial bus (USB) protocol, a multimedia card (MMC) protocol, a peripheral component interconnection (PCI) protocol, a PCI-Express (PCI-E) protocol, an advanced technology attachment (ATA) protocol, a serial-ATA (SATA) protocol, an external SATA (ESATA) protocol, a parallel-ATA (PATA) protocol, a small component small interface (SCSI) protocol, an enhanced small disk interface (ESDI) protocol, or an integrated drive electronics (IDE) protocol.

Data input from host 300 through host interface 144, or data transmitted to host 300 is transferred through cache buffer 146 without passing through system bus 141, under the control of CPU 142.

Cache buffer 146 temporarily stores mobile data transferred between host 300 and flash memories 120, or it stores a program that is managed and executed by CPU 142. The executed program can be stored in flash memories 120 or a separate RAM (not shown).

Cache buffer 146 is a type of buffer memory, and it can comprise a volatile memory device. In some embodiments, cache buffer 146 comprises an SRAM or a DRAM. In the embodiment of FIG. 2, cache buffer 146 is included in memory controller 140. However, the inventive concept is not limited to this configuration. For example, cache buffer 146 could alternatively be disposed outside memory controller 140.

Flash interface 148 provides an interface between memory controller 140 and flash memories 120 to access data. Flash interface 148 may aid a NAND flash memory, a One-NAND flash memory, a multi-level flash memory, or a single level flash memory.

Although not shown in FIG. 2, memory controller 140 can further comprise an error correction code (ECC) engine for correcting errors in flash memories 120.

As described with reference to FIG. 1, storage device 100 comprises lock mode management module 101 implemented in firmware for managing the lock mode.

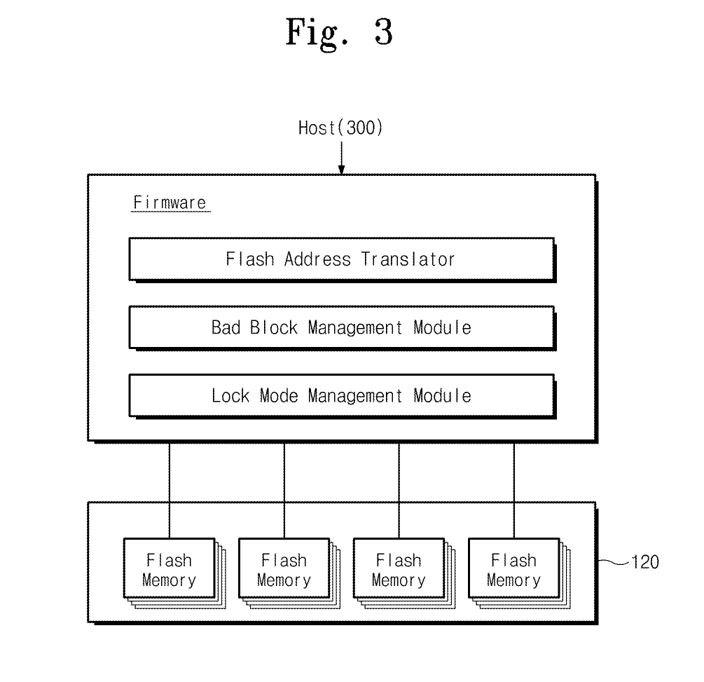

FIG. 3 is a block diagram illustrating the firmware of storage device 100 of FIG. 2 according to an embodiment of the inventive concept.

Referring to FIG. 3, the firmware manages flash memories 120, and comprises a flash address translator, a bad block management block, and a lock mode management module.

Where host 300 requests a read or write operation, an input logic address does not correspond to physical addresses of flash memories 120 in a one-to-one relationship. The flash address translator translates a logic address input from host 300 to a corresponding physical address among the physical addresses of flash memories 120.

In receiving of a writing request, the bad block management module registers a bad block or replaces the bad block with a reserved block when a programming operation is failed or an erasing operation is failed.

The lock mode management module monitors the number of reserved blocks of flash memories 120 or the number of reserved blocks of each of flash memories 120. Where the number of reserved blocks is less than or equal to a reference value, the lock mode management module places storage device 100 in the soft lock mode.

After storage device 100 enters the soft lock mode, the lock mode management module transmits a lock mode entry signal indicating that the soft lock mode has been entered, to host 300.

In response to the soft lock mode entry signal, a user performs the disk mounting operation, and then the lock mode management module places storage device 100 in the hard lock mode. In some embodiments, new metadata is stored after entering of the soft lock mode, and thereafter the lock mode management module determines completion of the disk mounting operation to enter the hard lock mode. In other embodiments, the lock mode management module enters the hard lock mode in response to a disk mounting operation completion signal inputted from the user.

The firmware initiates the soft lock mode according to the number of reserved blocks in flash memories 120, and then initiates the hard lock mode after the disk mounting operation.

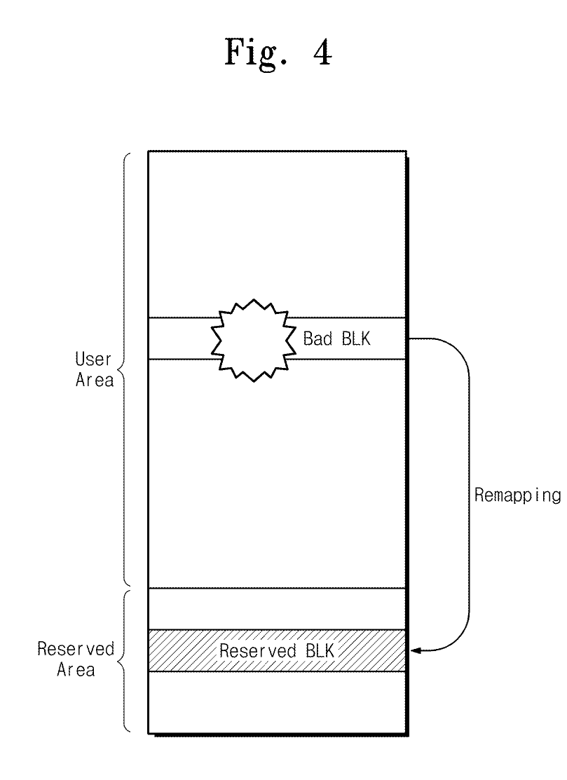

FIG. 4 is a diagram illustrating a bad block processing method performed by the bad block management module of FIG. 3 according to an embodiment of the inventive concept.

Referring to FIG. 4, each of flash memories 120 in FIG. 3 comprises a user area and a reserved area. The user area comprises a plurality of data blocks, and the reserved area comprises a plurality of reserved blocks.

When the data blocks are deemed to be failed in a writing/reading operation, the bad block management module registers a corresponding data block as a bad block, and remaps one of the reserved blocks to a new data block.

In some embodiments, the number of reserved blocks is less than 10% of the number of data blocks. Where data blocks are excessively registered as bad blocks, the number of reserved blocks becomes insufficient, and thus it may be difficult to perform remapping. In this case, the bad block management module performs management in order for a corresponding flash memory to be putted in the read-only mode.

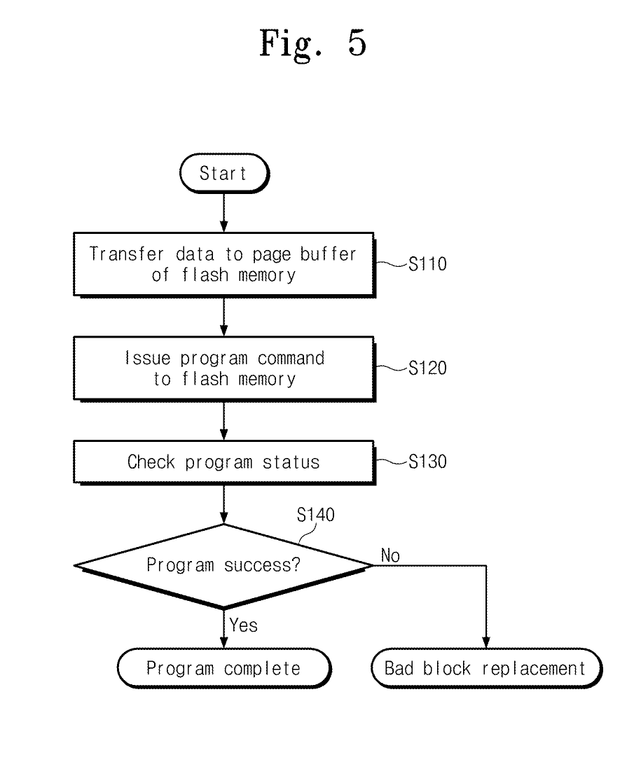

FIG. 5 is a flowchart illustrating a bad block replacing method performed in the programming operation of flash memory 120 of FIG. 2 according to an embodiment of the inventive concept.

Referring to FIG. 5, a programming operation of a flash memory is performed as follows. Data to be programmed is transferred to a page buffer of the flash memory in an operation S110, and a program command is issued to the flash memory in an operation S120. The programming operation can be performed according to the issued program command. Subsequently, a program status is checked in an operation S130, and an operation S140 determines whether programming has successively been performed. At this point, if the programming operation succeeds (S140=Yes), the programming operation is completed. On the other hand, where the programming operation does not succeed (S140=No), a bad block replacing operation is performed.

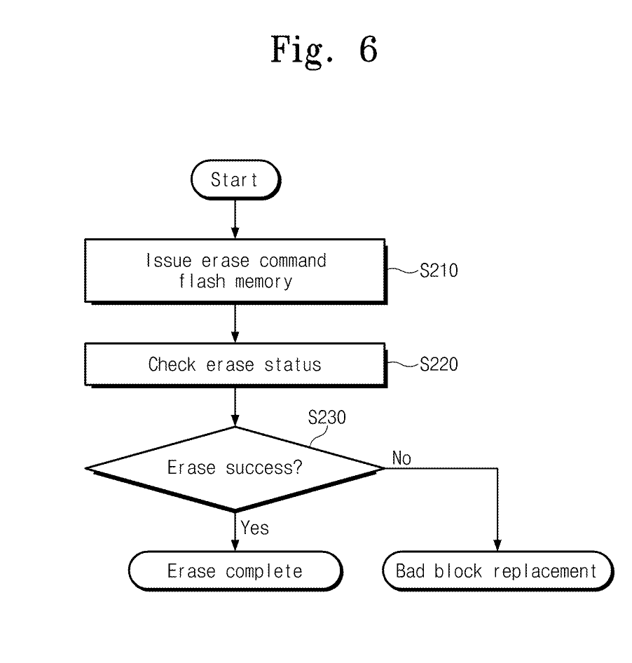

FIG. 6 is a flowchart illustrating a bad block replacing method in the erasing operation of flash memory 120 of FIG. 2 according to an embodiment of the inventive concept.

Referring to FIG. 6, an erasing operation of a flash memory is performed as follows. An erasure command is issued to the flash memory in an operation S210. The erasing operation of the flash memory is performed according to the issued erasure command. Subsequently, an erasing operation status is checked in an operation S220, and an operation S230 determines whether erasure has successively been performed. At this point, where the erasing operation succeeds (S230=Yes), the erasing operation is completed. On the other hand, where the erasing operation does not succeed (S230=No), a bad block replacing operation is performed.

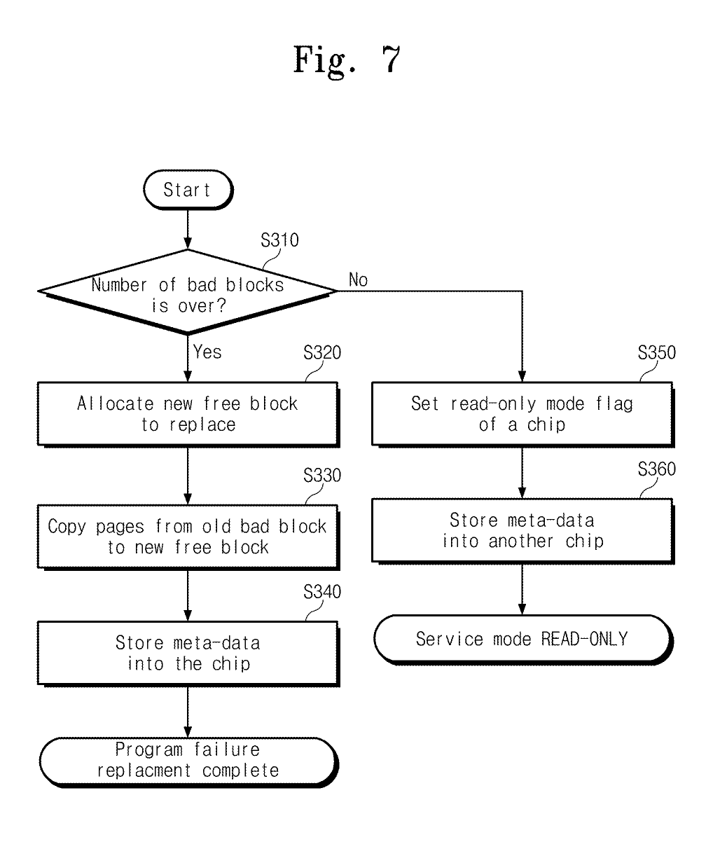

FIG. 7 is a flowchart illustrating the bad block replacing operation in FIGS. 5 and 6 according to an embodiment of the inventive concept.

Referring to FIG. 7, a bad block replacing operation is performed as follows. Where the programming operation is failed, memory controller 130 determines whether the number of bad blocks generated up to date is over the number of reserved blocks that have been prepared for replacement in operation S310.

Where the number of bad blocks is not greater than the number of reserved blocks (S310=No), the bad block management module allocates a new free block capable for replacement in an operation S320. Subsequently, previous data stored in a bad block is copied to the new free block in an operation S330, and then a block mapping table is updated. Data corresponding to the updated mapping table is stored in a corresponding flash memory in an operation S340. Therefore, a block replacing operation is completed when the programming operation is failed.

On the other hand, where the number of bad blocks is over the number of reserved blocks (S310=Yes), it is impossible to further perform the block replacing operation. Therefore, the bad block management module updates metadata comprising a flag that indicates a mapping status of a flash memory incapable of block replacement in an operation S350. Herein, the metadata may not be stored in the flash memory incapable of block replacement. Therefore, the flash memory incapable of block replacement is set to the read-only mode. That is, a service mode of the flash memory incapable of block replacement is the read-only mode.

Metadata of all flash memories is stored in a meta block of each of flash memories 120. Therefore, even where a specific flash memory cannot be read or written due to occurrence of a failure, a service mode can be controlled for the failed flash memory with metadata stored in another flash memory. For example, where a specific flash memory cannot further provide a read/write mode service, a read-only mode service may be controlled on the basis of meta information of another flash memory.

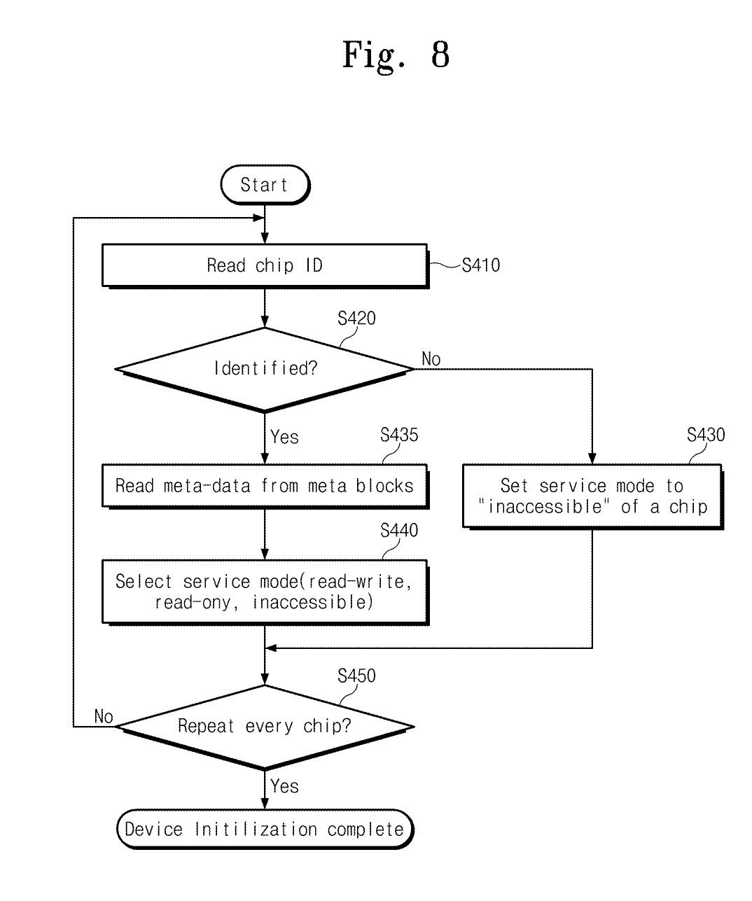

FIG. 8 is a flowchart illustrating an initializing operation of storage device 100 according to an embodiment of the inventive concept.

Referring to FIG. 8, an initializing operation of each of flash memories 120 is performed as follows.

First, memory controller 140 reads identification (ID) from each of flash memories 120 in an operation S410. At this point, memory controller 140 determines whether the read flash memory is recognized in an operation S420.

Where the flash memory is not recognized (S420=No), memory controller 140 updates metadata in order for a corresponding flash memory to be set to the inaccessible mode in an operation S430. Subsequently, an operation S450 is performed.

On the other hand, where a flash memory is recognized (S420=Yes), memory controller 140 reads metadata from at least one meta block of at least one flash memory in an operation S435. A service mode of the flash memory is selected from the read metadata in an operation S440. Herein, the service mode is one of the read/write mode, the read-only mode and the inaccessible mode.

Subsequently, memory controller 140 determines whether initialization is performed for all flash memories in an operation S450. Where the initializing operation is not performed for all flash memories (S450=No), operation S410 is performed.

However, where the initializing operation is performed for all flash memory chips (S450=Yes), the initializing operation of storage device 100 is completed.

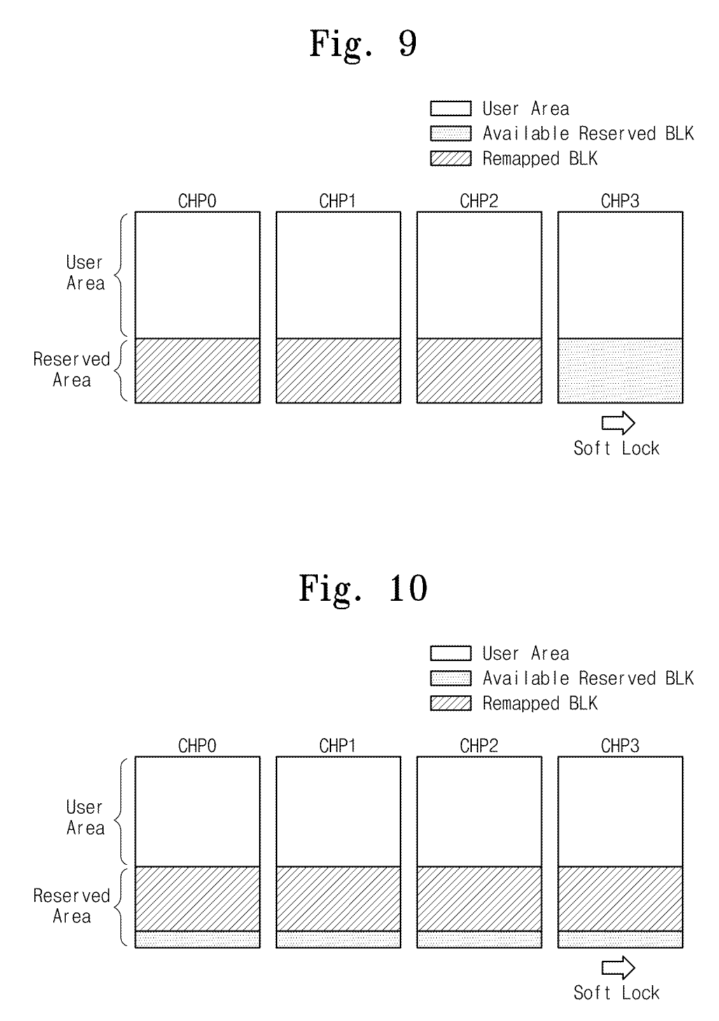

FIG. 9 is a diagram for describing a first embodiment of a soft lock mode entry time of storage device 100 in FIG. 2. For convenience, only four flash memories CHP0 through CHP3 are illustrated.

Referring to FIG. 9, lock mode management module 101 places storage device 100 in the soft lock mode when reserved blocks of the first through third flash memories CHP0 through CHP2 become blocks to which bad blocks are remapped.

FIG. 10 is a diagram for describing a first embodiment of a soft lock mode entry time of storage device 100 in FIG. 2.

Referring to FIG. 10, lock mode management module 101 places storage device 100 in the soft lock mode where the number of reserved blocks of each of first through fourth flash memories CHP0 through CHP3 is less than or equal to a reference value or the total number of reserved blocks of the first to fourth flash memories CHP0 through CHP3 is less than or equal to the reference value.

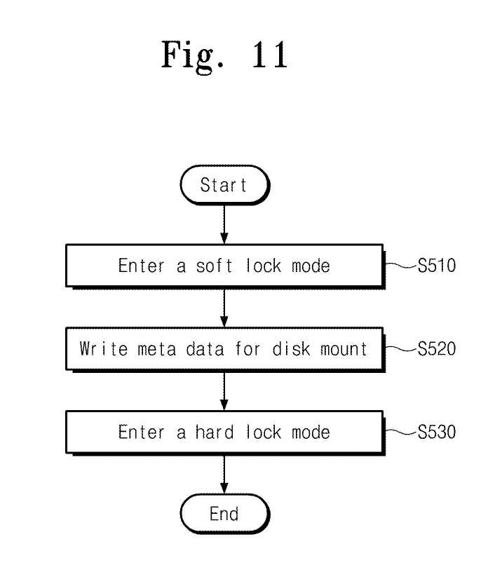

FIG. 11 is a flowchart illustrating a lock mode management method of a storage device according to an embodiment of the inventive concept. For convenience, it is assumed that the method is performed by storage device 100 of FIG. 2.

Referring to FIGS. 2, 3, and 11, a lock mode management method of storage device 100 is as follows. Where the number of reserved blocks of flash memories 120 is less than or equal to a reference value, lock mode management module 101 places storage device 100 in the soft lock mode in an operation S510. A user performs a disk mounting operation that copies data of storage device 100 to another storage device on the basis of information related to placing storage device 100 in the soft lock mode. As the disk mounting operation is performed, metadata is written in flash memories 120 in an operation S520. After the entering of the soft lock mode, lock mode management module 101 places storage device 100 in the hard lock mode when metadata is written in an operation S530.

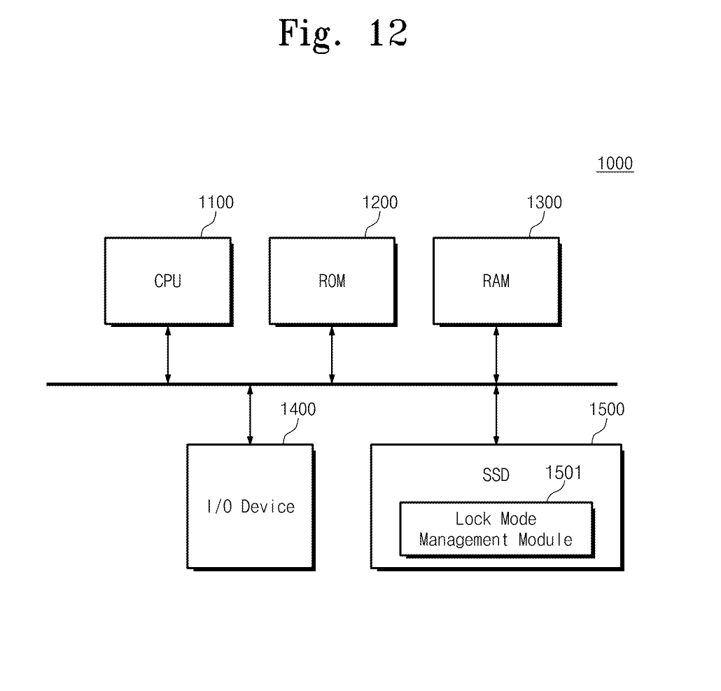

FIG. 12 is a block diagram illustrating a computing system 1000 incorporating a storage device according to an embodiment of the inventive concept.

Referring to FIG. 12, computing system 1000 comprises a CPU 1100, a ROM 1200, a RAM 1300, an input/output device 1400, and an SSD 1500. CPU 1100 is connected to a system bus. ROM 1200 stores data necessary for driving computing system 1000. As such data, there is an initial command sequence or a basic input/output (BIOS) sequence. RAM 1300 temporarily stores data that is generated when CPU 1100 is executed.

In some embodiments, input/output device 1400 is a keyboard, a pointing device (for example, a mouse), a monitor, a modem, etc., and it is connected to the system bus through an input/output device interface. SSD 1500 is a readable storage device, and it can be implemented similar to SSD 100 of FIG. 2. SSD 1500 comprises a lock mode management module 1501 for managing a lock mode. The lock mode management module 1501 can be configured similar to the lock mode management module of FIG. 3.

Computing system 1000 stores large-scale data in SSD 1500, which can reduce power consumption. Accordingly, computing system 1000 can largely extend service life of a battery.

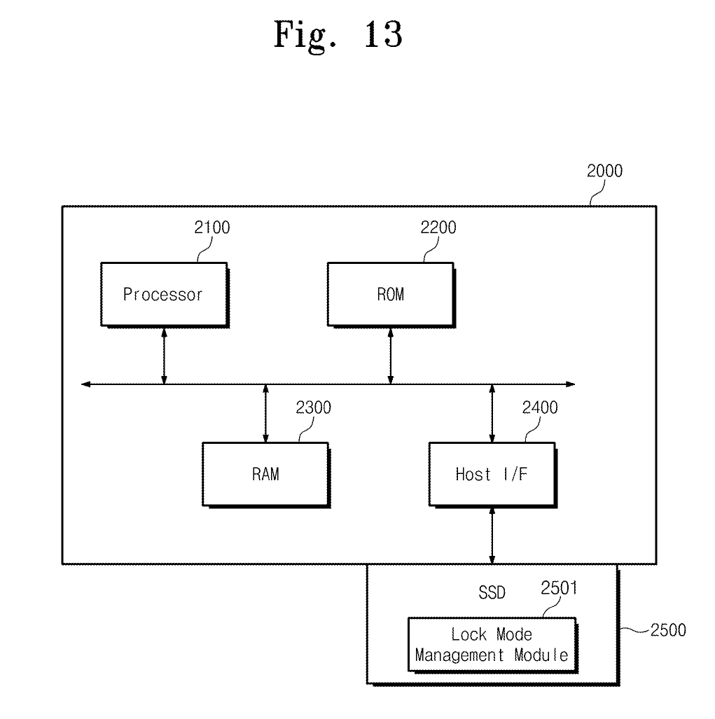

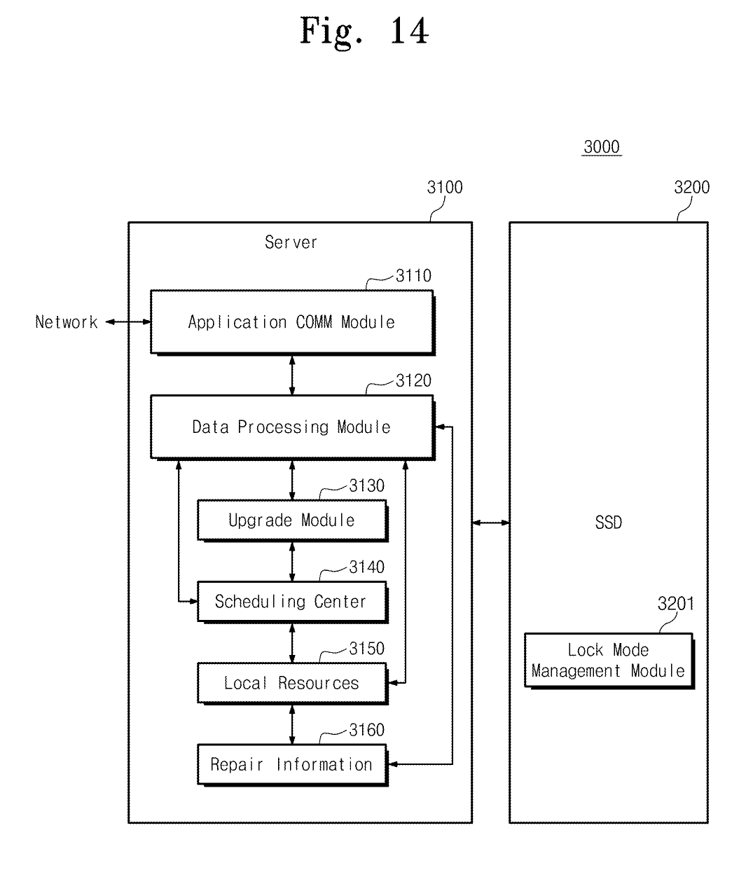

FIG. 13 is a block diagram illustrating an electronic appliance 2000 incorporating a storage device according to an embodiment of the inventive concept.

Referring to FIG. 13, electronic appliance 2000 comprises a processor 2100, a ROM 2200, a RAM 2300, a host interface 2400, and an SSD 2500.

Processor 2100 accesses RAM 2300 to execute firmware code or an arbitrary code. Also, processor 2100 accesses ROM 2200 for executing a plurality of fixed command sequences such as an initial command sequence and a basic input/output operation system sequence.

Host interface 2400 provides an interface between electronic appliance 2000 and SSD 2500. Host interface 2400 implements a protocol for exchanging data between electronic appliance 2000 and SSD 2500. As examples, the protocol can be a standard interface protocol, such as a USB protocol, an MMC protocol, a PCI protocol, a PCI-E protocol, an ATA protocol, a SATA protocol, an ESATA protocol, a PATA protocol, an SCSI protocol, an ESDI protocol, or an IDE protocol.

SSD 2500 can be attached or detached to or from electronic appliance 2000. SSD 2500 is configured identically to SSD 100 of FIG. 2. SSD 2500 comprises a lock mode management module 2501 for managing a lock mode. The lock mode management module 2501 can be implemented similar to the lock mode management module of FIG. 3.

Electronic appliance 2000 can take various forms, such as a cellular phone, a PDA, a digital camera, a camcorder, a portable audio player, or a PMP, for example.

Electronic appliance 2000 stores large-scale data in SSD 2500 to reduce power consumption. Thus, electronic appliance can provide benefits for portable electronic devices requiring long battery life.

FIG. 14 is a block diagram illustrating a server system 3000 incorporating a storage device according to an embodiment of the inventive concept.

Referring to FIG. 14, server system 3000 comprises a server 3100 and an SSD 3200 storing data necessary for driving server 3100.

Server 3100 comprises an application communication module 3110, a data processing module 3120, an upgrade module 3130, a scheduling center 3140, a local resource module 3150, and a repair information module 3160.

Application communication module 3110 communicates with a computing system connected to server 3100 over a network, or allows server 3100 to communicate with SSD 3200. Application communication module 3110 transmits data or other information provided through a user interface to data processing module 3120.

Data processing module 3120 is linked to local resource module 3150. Herein, local resource module 3150 applies a list of repair shops/dealers/technical information to a user, on the basis of data or information inputted to server 3100.

Upgrade module 3130 interfaces with data processing module 3120. Upgrade module 3130 upgrades a firmware, a reset code and a diagnosis system on the basis of data or information that is transmitted from SSD 3200, or upgrades an electronic appliance with other information.

Scheduling center 3140 allows a real-time option to a user on the basis of data or information that is input to server 3100.

Repair information module 3160 interfaces with data processing module 3120. Repair information module 3160 is used to provide repair-related information (for example, audio, video or document files) to a user. Data processing module 3120 packages relevant information on the basis of information that is transferred from SSD 3200. Subsequently, such information is transmitted to SSD 3200 or displayed to the user.

SSD 3200 can be implemented with the same configuration and operation as SSD 100 of FIG. 2. In some embodiments, SSD 3200 comprises a super cap array (not shown) and a cell balancing circuit (not shown). Moreover, in some embodiments, SSD 3200 comprises a lock mode management module 3201 for managing a lock mode. The lock mode management module 3201 can be configured similar to lock mode management module 101 of FIG. 3.

Server system 3000 comprises SSD 3200 that comprises an auxiliary power source with enhanced performance, largely enhancing reliability of data. Furthermore, server system 3000 stores data or information in SSD 3200 where stored data is not erased even when a power source is disconnected, and thus can largely decrease power consumption compared to an HDD.

The storage device according to embodiments of the inventive concept may be mounted with various types of packages. For example, the storage device according to embodiments of the inventive concept may be mounted with packages such as package on package (PoP), ball grid arrays (BGAs), chip scale packages (CSPs), plastic leaded chip carrier (PLCC), plastic dual in-line package (PDIP), die in waffle pack (DIWP), die in wafer form (DIWF), chip on board (COB), ceramic dual in-line package (CERDIP), plastic metric quad flat pack (MQFP), thin quad flat pack (TQFP), small outline package (SOP), shrink small outline package (SSOP), thin small outline package (TSOP), thin quad flat pack (TQFP), system in package (SIP), multi chip package (MCP), wafer level stack package (WLSP), die in wafer form (DIWF), die on waffle package (DOWP), wafer-level fabricated package (WFP) and wafer-level processed stack package (WSP).

As indicated by the foregoing, a storage device, lock mode management method, and memory system can make use of a lock mode management module to a soft lock mode where writing is allowed. This can facilitate data back up operations for a user.

The above-disclosed subject matter is to be considered illustrative and not restrictive, and the appended claims are intended to cover all such modifications, enhancements, and other embodiments, which fall within the scope of the inventive concept. To the maximum extent allowed by law, the scope of the inventive concept is to be determined by the broadest permissible interpretation of the following claims and their equivalents, and shall not be restricted or limited by the foregoing detailed description.

What is claimed is:

1. A storage device, comprising:
at least one nonvolatile memory comprising a plurality of reserved blocks; and
a lock mode management module that places the storage device in a soft lock mode upon determining that the number of reserved blocks is less than or equal to a reference value, wherein the soft lock mode allows a predetermined writing operation while disallowing another writing operation.

2. The storage device of claim 1, wherein the at least one nonvolatile memory is a flash memory.

3. The storage device of claim 2, wherein the flash memory comprises:
a user area comprising a plurality of data blocks that store user data; and
a reserved area that provides a block for replacing an allocated bad block.

4. The storage device of claim 3, wherein the flash memory identifies a data block as a bad block upon determining that a programming operation of the data block has failed.

5. The storage device of claim 3, wherein the flash memory identifies a data block as bad block upon determining that an erase operation of the data block has failed.

6. The storage device of claim 3, wherein in replacing of the bad block, the flash memory allocates a reserved block corresponding to the bad block, copies data from the bad block to the allocated reserved block, and stores metadata comprising changed block mapping table information.

7. The storage device of claim 1, wherein the lock mode management module comprises firmware.

8. The storage device of claim 7, wherein the at least one nonvolatile memory comprises a plurality of flash memories, and the lock mode management module places the storage device in the soft lock mode when a reserved block does not exist in at least one of the flash memories.

9. The storage device of claim 7, wherein the at least one nonvolatile memory comprises a plurality of flash memories, and the lock mode management module places the storage device in the soft lock mode where the total number of reserved blocks of the flash memories is less than or equal to a reference value.

10. The storage device of claim 1, wherein the predetermined writing operation comprises a writing operation of a disk mounting operation to back up data from the storage device to another storage device.

11. The storage device of claim 10, wherein the disk mounting operation is performed by a user after determining that the storage device has entered the soft lock mode.

12. The storage device of claim 10, wherein the lock mode management module places the storage device into a hard lock mode after the disk mounting operation, wherein the hard lock mode is a read-only mode of the storage device.

13. The storage device of claim 12, wherein the lock mode management module places the storage device in the hard lock mode after metadata associated with the disk mounting operation is stored in the storage device.

14. The storage device of claim 12, wherein the lock mode management module places the storage device in the hard lock mode in response to a hard lock mode entry signal.

15. A lock mode management method for a storage device comprising a plurality of flash memories, the method comprising:
placing the storage device in a soft lock mode upon determining that a number of reserved blocks of the flash memories is less than or equal to a reference value;
performing a disk mounting operation to copy data from the storage device to another storage device while the storage device is in the soft lock mode;
storing metadata related to the disk mounting operation; and
after storing the metadata related to the disk mounting operation, placing the storage device in a hard lock mode.

16. The method of claim 15, further comprising:
replacing a bad block of one of the flash memories by allocating a reserved block in a reserved area, copying data from the bad block to the allocated reserved block, and storing metadata comprising changed block mapping table information.

17. The method of claim 16, further comprising:
identifying the bad block in response to a failure of a program or erase operation.

18. An information processing system, comprising:
a host device; and
a storage device responsive to commands provided from the host device, and comprising at least one nonvolatile memory comprising a plurality of reserved blocks, and a lock mode management module that places the storage device in a soft lock mode upon determining that the number of reserved blocks is less than or equal to a reference value, wherein the soft lock mode permits a predetermined writing operation to be performed while preventing another writing operation from being performed.

19. The information processing system of claim 18, wherein the storage device is a solid state drive.

20. The information processing system of claim 18, wherein the predetermined writing operation comprises a writing operation of a disk mounting operation to back up data from the storage device to another storage device.
